(19) United States
(12) Patent Application Publication
(10) Pub. No.: US 2026/0203288 A1
(43) Pub. Date: Jul. 16, 2026

(54) BOTTOM-UP PLAN RECONSTRUCTION FOR SQL QUERY OPTIMIZATION

(71) Applicant: Snowflake Inc., Bozeman, MT (US)

(72) Inventors: Sangyong Hwang, Sammamish, WA (US); Wesley A. Leung, Bellevue, WA (US); Dan Bi Park, Seattle, WA (US); Sourav Sikdar, Houston, TX (US); Li Yan, Redmond, WA (US)

(21) Appl. No.: 19/020,807

(22) Filed: Jan. 14, 2025

(51) Int. Cl. G06F 16/2453

(52) U.S. Cl. CPC G06F 16/24544

(57) ABSTRACT

The subject technology receives an initial query plan. The subject technology receives a directive specifying a join order hint. The subject technology performs a bottom-up plan reconstruction process on the initial query plan based on the directive, the bottom-up plan reconstruction process generating a transformed query plan that conforms to the join order hint specified in the directive. The subject technology generates a transformed query plan that conforms to the join order hint specified in the directive. The subject technology provides the transformed query plan to an execution node for executing the transformed query plan.

### TECHNICAL FIELD

Embodiments of the disclosure relate generally to cloud data platforms and, more specifically, to query optimizations in data platforms.

### BACKGROUND

Data platforms are widely used for data storage and data access in computing and communication contexts. With respect to architecture, a data platform could be an on-premises data platform, a network-based data platform (e.g., a cloud-based data platform), a combination of the two, and/or include another type of architecture. With respect to type of data processing, a data platform could implement online transactional processing (OLTP), online analytical processing (OLAP), a combination of the two, and/or another type of data processing. Moreover, a data platform could be or include a relational database management system (RDBMS) and/or one or more other types of database management systems.

A data platform may store database data (e.g., a table) in multiple storage units, which may be referred to as partitions, micro-partitions, and/or by one or more other names. A database may be organized as records (e.g., rows or a collection of rows) that each include one or more attributes (e.g., columns). In an example, multiple storage units of a database can be stored in a block and multiple blocks can be grouped into a single file. That is, a database can be organized into a set of files where each file includes a set of blocks, where each block includes a set of more granular storage units such as partitions. It should be understood that the terms “row” and “column” are used for illustration purposes and these terms are interchangeable. For example, data arranged in a column of a table can similarly be arranged in a row of the table.

Users and/or executing processes that are associated with a given customer account may, via one or more types of clients, be able to cause data to be ingested into the database, and may also be able to manipulate the data, add additional data, remove data, run queries against the data, generate views of the data, and so forth.

When certain information is to be extracted from a database, a query statement may be executed against the database data. A data platform may process the query and return certain data according to one or more query predicates that indicate what information should be returned by the query. The data platform extracts specific data from the database and formats that data into a readable form.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a cloud data platform, in accordance with some embodiments of the present disclosure

FIG. 2 is a block diagram illustrating components of a compute service manager of the cloud data platform, in accordance with some embodiments of the present disclosure.

FIG. 3 illustrates an example processing flow for a set of operations of an example query compilation and query optimization involving bottom-up plan reconstruction, in accordance with some embodiments of the present disclosure.

FIG. 4 illustrates an example of an input query plan with an arbitrary join order, in accordance with an embodiment of the subject technology.

FIG. 5 illustrates an example output query plan matching the join order hint, in accordance with an embodiment of the subject technology.

FIG. 6 illustrates an example of an input query plan with a query block with inner join only, in accordance with an embodiment of the subject technology.

FIG. 7 illustrates an example of a query plan illustrating a reconstruction step for optimal join key derivation, in accordance with an embodiment of the subject technology.

FIG. 8 illustrates an example of a query plan showing a reconstruction step for the construction of the (final) query plan shape, in accordance with an embodiment of the subject technology.

FIG. 9 illustrates an example of a query plan including a query block with non-inner join processing, in accordance with an embodiment of the subject technology.

FIG. 10 illustrates an example of a query plan in a reconstruction step for optimal join key derivation, in accordance with an embodiment of the subject technology.

FIG. 11 illustrates an example of a query plan in a reconstruction step of constructing the query plan shape, in accordance with an embodiment of the subject technology.

FIG. 12 is a flow diagram illustrating operations of a database system in performing a method, in accordance with some embodiments of the present disclosure.

FIG. 13 is a flow diagram illustrating operations of a database system in performing a method, in accordance with some embodiments of the present disclosure.

FIG. 14 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

Reference will now be made in detail to specific example embodiments for carrying out the inventive subject matter. Examples of these specific embodiments are illustrated in the accompanying drawings, and specific details are set forth in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

Traditional rule-based hint application frameworks may not handle bushy joins. The disclosed framework supports bushy joins in an implementation.

More specifically, the subject technology provides a bottom-up plan reconstruction framework that applies join order hints late in the compilation process, just before Cost-Based Optimization (CBO). This approach reconstructs the query plan from an already constructed plan, supporting joins introduced after query block translation and handling bushy joins by design, and is more efficient than transformation-based approaches.

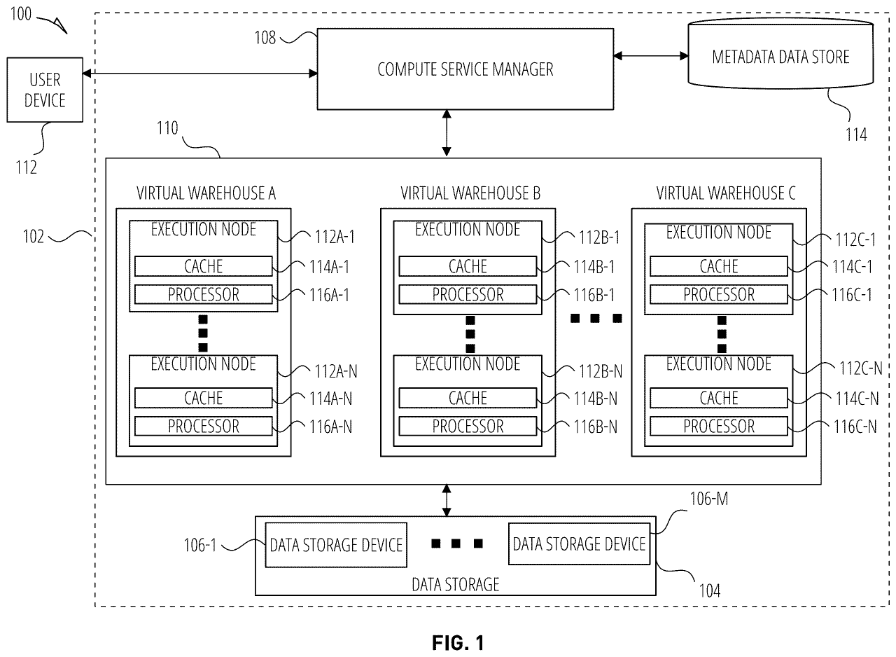

FIG. 1 illustrates an example computing environment 100 that includes a data platform 102, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein.

As shown, the data platform 102 comprises a three-tier architecture: a compute service manager 108 coupled to a metadata data store 114, an execution platform 110, and data storage 104. The data platform 102 hosts and provides data access, management, reporting, and analysis services to multiple client accounts. Administrative users can create and manage identities (e.g., users, roles, and groups) and use permissions to allow or deny access to the identities to resources and services. The data platform 102 is used for reporting and analysis of integrated data from one or more disparate sources including storage devices within the data storage 104. The data storage 104 comprises a plurality of computing machines and provides on-demand computer system resources such as data storage and computing power to the data platform 102.

The compute service manager 108 includes multiple services that coordinate and manage operations of the data platform 102. For example, the compute service manager 108 is responsible for performing query optimization and compilation as well as managing clusters of compute nodes that perform query processing (also referred to as “virtual warehouses”). The compute service manager 108 can support any number of client accounts such as end users providing data storage and retrieval requests, system administrators managing the systems and methods described herein, and other components/devices that interact with compute service manager 108.

The compute service manager 108 is also coupled to the metadata data store 114. The metadata data store 114 stores metadata pertaining to various functions and aspects associated with the data platform 102 and its users. The metadata data store 114 also includes a summary of data stored in data storage 104 as well as data available from local caches. Additionally, the metadata data store 114 includes information regarding how data is organized in the data storage 104 and the local caches.

The compute service manager 108 is also in communication with a user device 112. The user device 112 corresponds to a user of one of the multiple client accounts supported by the data platform 102. In some implementations, the compute service manager 108 does not receive any direct communications from the user device 112 and only receives communications concerning jobs from a queue within the data platform 102.

The compute service manager 108 is also coupled to the metadata data store 114. The metadata data store 114 stores metadata pertaining to various functions and aspects associated with the data platform 102 and its users. The metadata data store 114 also includes a summary of data stored in data storage 104 as well as data available from local caches. Additionally, the metadata data store 114 includes information regarding how data is organized in the data storage 104 and the local caches.

The compute service manager 108 is further coupled to the execution platform 110, which includes multiple virtual warehouses (computing clusters) that execute various data storage and data retrieval tasks. As an example, a set of processes on a compute node executes at least a portion of a query plan compiled by the compute service manager 108. As shown, the execution platform 110 includes virtual warehouse A, virtual warehouse B, and virtual warehouse C. Each virtual warehouse includes multiple execution nodes that each includes a data cache and a processor. For example, as shown, virtual warehouse A includes execution node 112A-1 to 112A-N; execution node 112A-1 includes a cache 114A-1 and a processor 116A-1; and execution node 112A-N includes a cache 114A-N and a processor 116A-N. Similarly, in this example, virtual warehouse B includes execution node 112B-1 to 112B-N; execution node 112B-1 includes a cache 114B-1 and a processor 116B-1; and execution node 112B-N includes a cache 114B-N and a processor 116B-N. Additionally, virtual warehouse C includes execution node 112C-1 to 112C-N; execution node 112C-1 includes a cache 114C-1 and a processor 116C-1; and execution node 112C-N includes an execution node 112C-N and a processor 116C-N.

Each execution node of the execution platform 110 is assigned to processing one or more data storage and/or data retrieval tasks. Hence, the virtual warehouses can execute multiple tasks in parallel utilizing the multiple execution nodes. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

In some examples, the execution nodes of the execution platform 110 are stateless with respect to the data the execution nodes are caching. That is, the execution nodes do not store or otherwise maintain state information about the execution node or the data being cached by a particular execution node, in these examples. Thus, in the event of an execution node failure, the failed node can be transparently replaced by another node. Since there is no state information associated with the failed execution node, the new (replacement) execution node can easily replace the failed node without concern for recreating a particular state.

The execution platform 110 may include any number of virtual warehouses. Additionally, the number of virtual warehouses in the execution platform 110 is dynamic, such that new virtual warehouses are created when additional processing and/or caching resources are needed. Similarly, existing virtual warehouses may be deleted when the resources associated with the virtual warehouse are no longer necessary.

Although each virtual warehouse shown in FIG. 1 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary. Additionally, although the execution nodes shown in the example of FIG. 1 each include a single data cache and a single processor, in other examples, execution nodes can contain any number of processors and any number of caches. Also, the caches may vary in size among the different execution nodes.

In some examples, the virtual warehouses of the execution platform 110 operate on the same data, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

Although virtual warehouses A, B, and C are illustrated with an association with the same execution platform 110, the virtual warehouses may be implemented using multiple computing systems at multiple geographic locations. For example, virtual warehouse A can be implemented by a computing system at a first geographic location, while virtual warehouses B and C are implemented by another computing system at a second geographic location. In some examples, these different computing systems are cloud-based computing systems maintained by one or more different entities.

The execution platform 110 is coupled to data storage 104. The data storage 104 comprises multiple data storage devices 106-1 to 106-M. In some embodiments, the data storage devices 106-1 to 106-M are cloud-based storage devices located in one or more geographic locations. For example, the data storage devices 106-1 to 106-M may be part of a public cloud infrastructure or a private cloud infrastructure. The data storage devices 106-1 to 106-M may be hard disk drives (HDDs), solid state drives (SSDs), storage clusters, Amazon S3™ storage systems or any other data storage technology. Additionally, the data storage 104 may include distributed file systems (e.g., Hadoop Distributed File Systems (HDFS)), object storage systems, and the like. In some examples, the data storage devices 106-1 to 106-M are managed and provided by a third-party data storage platform (e.g., AWS®, Microsoft Azure Blob Storage®, or Google Cloud Storage®).

Each virtual warehouse can access any of the data storage devices 106-1 to 106-M shown in FIG. 1. Thus, the virtual warehouses are not necessarily assigned to a specific data storage device 106-1 to 106-M and, instead, can access data from any of the data storage devices 106-1 to 106-M within the data storage 104. Similarly, each of the execution nodes shown in FIG. 1 can access data from any of the data storage devices 106-1 to 106-M. In some examples, a particular virtual warehouse or a particular execution node may be temporarily assigned to a specific data storage device, but the virtual warehouse or execution node may later access data from any other data storage device.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-networks) coupled to one another.

As shown in FIG. 1, the data storage devices 106-1 to 106-M are decoupled from the computing resources associated with the execution platform 110. This architecture supports dynamic changes to the data platform 102 based on the changing data storage/retrieval needs as well as the changing needs of the users and systems. The support of dynamic changes allows the data platform 102 to scale quickly in response to changing demands on the systems and components within the data platform 102. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

During typical operation, the data platform 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more execution nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in the metadata data store 114 assists the compute service manager 108 in determining which nodes in the execution platform 110 have already cached at least a portion of the data needed to process the task. One or more nodes in the execution platform 110 process the task using data cached by the nodes and, if necessary, data retrieved from the data storage 104.

The compute service manager 108, metadata data store 114, execution platform 110, and data storage 104 are shown in FIG. 1 as individual discrete components. However, each of the compute service manager 108, metadata data store 114, execution platform 110, and data storage 104 may be implemented as a distributed system (e.g., distributed across multiple systems/platforms at multiple geographic locations). Additionally, each of the compute service manager 108, metadata data store 114, execution platform 110, and data storage 104 can be scaled up or down (independently of one another) depending on changes to the requests received and the changing needs of the data platform 102. Thus, in the described embodiments, the data platform 102 is dynamic and supports regular changes to meet the current data processing needs.

As shown in FIG. 1, the computing environment 100 separates the execution platform 110 from the data storage 104. In this arrangement, the processing resources and cache resources in the execution platform 110 operate independently of the data storage devices 106-1 to 106-M in the data storage 104. Thus, the computing resources and cache resources are not restricted to specific data storage devices 106-1 to 106-M. Instead, all computing resources and all cache resources may retrieve data from, and store data to, any of the data storage resources in the data storage 104.

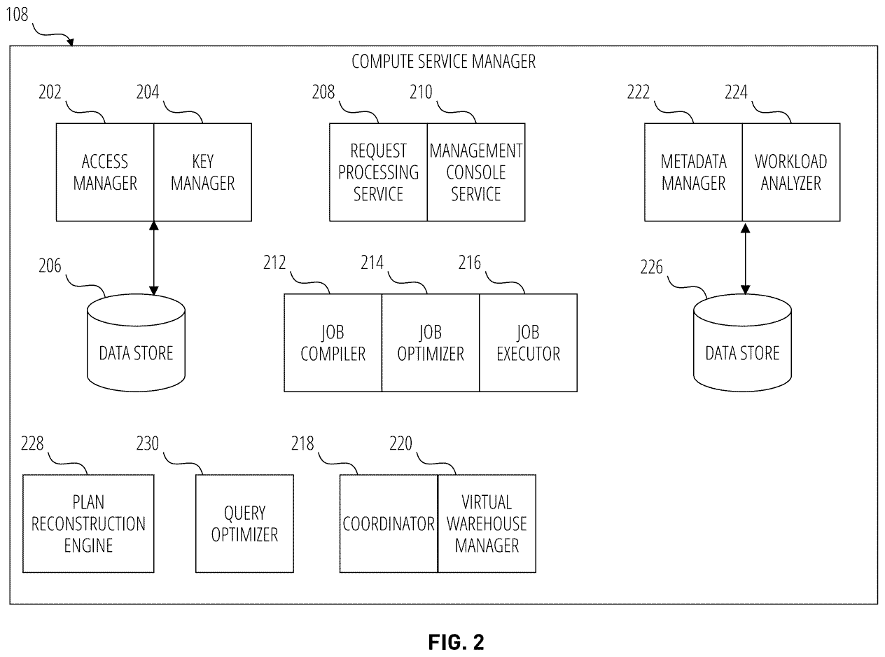

FIG. 2 is a block diagram illustrating components of the compute service manager 108, in accordance with some embodiments of the present disclosure. As shown in FIG. 2, the compute service manager 108 includes an access manager 202 and a key manager 204 coupled to a data store 206 that stores access information. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage devices (e.g., data storage devices in data storage 104).

A request processing service 208 manages received data storage requests and data retrieval requests (e.g., jobs to be performed on database data). For example, the request processing service 208 may determine the data necessary to process a received query (e.g., a data storage request or data retrieval request). The data may be stored in a cache within the execution platform 110 or in a data storage device in data storage 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and processed in that prioritized order. In some examples, the job scheduler and coordinator 218 identifies or assigns particular nodes in the execution platform 110 to process particular tasks.

A virtual warehouse manager 220 manages the operation of multiple virtual warehouses implemented in the execution platform 110. As discussed below, each virtual warehouse includes multiple execution nodes that each include a cache and a processor.

Additionally, the compute service manager 108 includes a configuration and metadata manager 222, which manages the information related to the data stored in the remote data storage devices and in the local caches (e.g., the caches in execution platform 110). The configuration and metadata manager 222 uses the metadata to determine which storage units need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the data platform 102 and may further redistribute tasks based on a user (e.g., “external”) query workload that may also be processed by the execution platform 110. The configuration and metadata manager 222 and the monitor and workload analyzer 224 are coupled to a data store 226. Data store 226 in FIG. 2 represents any data repository or device within the data platform 102. For example, data store 226 may represent caches in execution platform 110, storage devices in data storage 104, the metadata data store 114, or any other storage device or system.

In data processing systems that support SQL, a hint is often used as a directive to provide instructions to the query optimizer on how to execute a SQL query. Hints can be used to direct a query optimizer to choose a join order, choose indexes, or control other performance-related options. As further illustrated, the compute service manager 108 includes a plan reconstruction engine 228 and a query optimizer 230. In an example, the plan reconstruction engine 228 implements a bottom-up plan reconstruction framework that helps query optimizer 230 choose a particular join order, which enables generating specific join orders, with the capability of handling bushy join patterns.

In an example, a bushy join pattern is a type of join order in a query plan where joins are performed in a hierarchical or tree-like structure, rather than in a linear sequence. In a bushy join pattern, multiple joins can occur at different levels of the tree, allowing for more complex and flexible join orders. This contrasts with a linear join pattern, where joins are performed sequentially, one after the other.

In SQL-based data processing systems, hints serve as instructions that guide query optimizers in executing SQL queries efficiently. Query optimizers can leverage these hints to make key execution decisions, including determining join sequences, selecting appropriate indexes, and managing various performance parameters. Embodiments of the subject technology provide a join order hint application framework (e.g., as provided by plan reconstruction engine 228), referred to herein as “bottom-up plan reconstruction,” that enables the query optimizer (e.g., query optimizer 230) to generate specific join orders, with the distinct capability of handling bushy join patterns.

In some existing implementations, a bottom-up plan construction approach applies join order hints during a query block translation phase, constructing the initial query plan bottom-up from a parse tree structure. Such an approach can operate with two components:
1. Input: Parse tree including query blocks
2. Output: Hinted query plan

In contrast, the subject technology fundamentally differs from the above by at least focusing on plan reconstruction rather than initial construction. For example, instead of working with a parse tree, the subject system takes a pre-constructed query plan as input and performs a reconstruction process to generate the hinted query plan. Such a reconstruction-based approach offers several advantages:
Enables join order hint application at a later stage in compilation, specifically just before cost-based optimization (CBO)
Provides support for joins that are introduced after query block translation
Inherently supports bushy joins through its design architecture

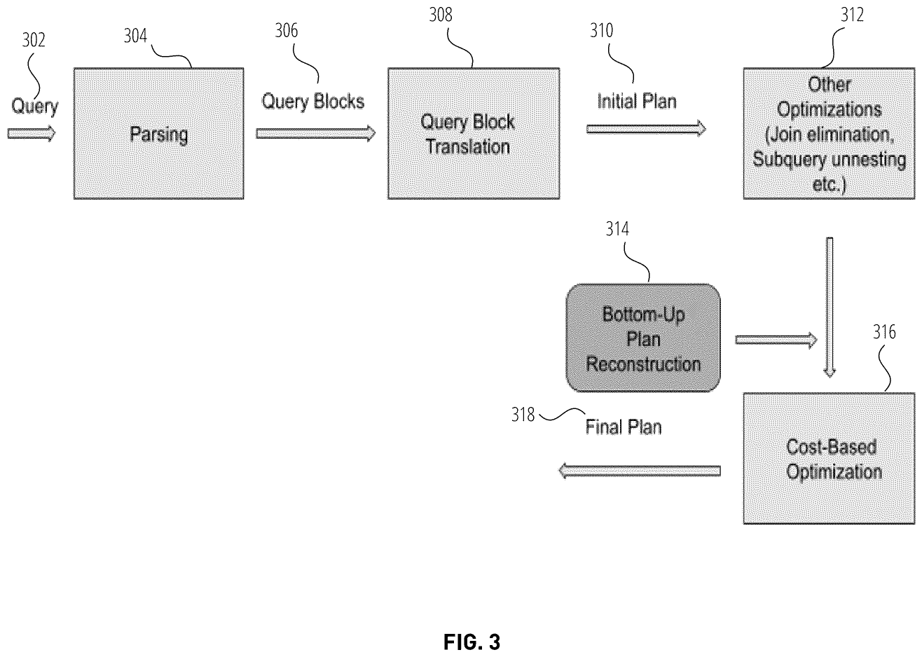

FIG. 3 illustrates an example processing flow for a set of operations of an example query compilation and query optimization involving bottom-up plan reconstruction, in accordance with some embodiments of the present disclosure.

The following discussion relates to aspects of a bottom-up plan reconstruction 314 (e.g., provided or enabled by plan reconstruction engine 228). In the example of FIG. 3, SQL query 302 can represent a given query plan with an arbitrary join order.

In a query compilation process shown in FIG. 3, an SQL query 302 after parsing 304 is usually broken into one or more smaller units called Query Blocks (QB) 306 where such query blocks undergo query block translation 308 to generate initial plan 310. Such QBs generally follow a tree structure, so each QB can have one or more child QBs. Each QB can be optimized independently (e.g., in other optimizations 312) before being combined to generate a complete execution plan for the query.

During query compilation, the parsed query is decomposed into modular components called query blocks (QB) (e.g., query blocks 306). In an example, such blocks are organized hierarchically in a tree structure, where individual query blocks may include multiple child blocks. This modular architecture enables each query block to undergo independent optimization before being integrated into a comprehensive execution plan. In an example, a query block functions as a discrete unit that contributes a specific segment to the query plan, or more specifically, a segment within which join operations can be reordered.

Query compilers often rely on predefined transformations or rules. As discussed further herein, embodiments of the subject technology, instead of in addition to predefined transformations or rules, provide a bottom-up plan reconstruction 314 to optimize a query plan. Bottom-up plan reconstruction 314 can receive an optimized plan from other optimizations 312 and a directive to generate a transformed query plan as discussed further herein. After the query plan is processed by bottom-up plan reconstruction (outputting a target query plan), a cost-based optimization 316 can be performed which then generates a final plan 318. In some embodiments, such a cost-based optimization can be skipped, thereby providing additional performance and a reduction of computing resource utilization.

As discussed herein, a directive specifying a join order hint is an instruction provided to a query optimizer (e.g., query optimizer 230) that indicates the desired sequence in which joins should be executed within a SQL query. This directive helps guide the optimizer in constructing the query plan to follow a specific join order, which can be crucial for optimizing query performance.

The directive can include key-value pairs that map specific join operations to their respective operands (tables or subqueries). Each key represents a unique identifier for a join operation, and the corresponding value specifies the operands involved in that join. The syntax of the directive ensures that the optimizer (e.g., query optimizer 230) can interpret and apply the join order hints correctly.

The following discussion relates to an example join order hint syntax.

In a query plan, each join node produces a hint structured as a key-value pair following this format: “qbx_y”: {“leftAlias”, “rightAlias”}

The components of this syntax are:
x: Identifies the specific query block
y: Provides a unique identifier for join nodes within that query block
leftAlias: Represents the alias for the join node's left child subtree
rightAlias: Represents the alias for the join node's right child subtree

In an example, an alias in the above example is a symbolic name or identifier used to represent a specific table, subquery, or plan fragment within a query plan. Aliases can be used in join order hints to clearly specify which tables or subqueries should be joined and in what order. By using aliases, the query optimizer can interpret and apply the join order hints to reconstruct the query plan according to the desired join sequence.

For a query block including N number of joins, the identifiers are sequentially assigned from 0 to (N−1).

In an implementation, the subject system uses SYS_JOIN_x_y aliases to track the progressive construction of join-trees within logical query blocks. Of particular importance are nodes that provide aliases without the SYS_JOIN_ prefix in the hint, known as terminal nodes (alternatively called “terminals,” “nodes with aliases,” or simply “nodes”).

Terminal nodes can fall under two categories:
1. Leaf Nodes: These represent the data source nodes within the query plan
2. Query Block Root: These correspond to the root/top nodes of a logical query block, where the query block represents a section of the query plan in which joins can be reordered

The following is an illustrative example that demonstrates the join order hint syntax discussed above, for the following SQL query:
SELECT*FROM A, B, C, D WHERE A.a1=B.b1 and B.b2=C.c2 and C.c3=D.d3;

This query uses four data sources: A, B, C, and D.

In an example, a join order hint can be structured as:
{“qb1_0”: [“A”, “B”], “qb1_1”: [“C”, “D”], “qb1_2”:
[“SYS_JOIN_1_0”, “SYS_JOIN_1_1”]}

The above directive would instruct the query optimizer to:
1. Join tables A and B
2. Join tables C and D
3. Join the results of these two operations together

The directive serves as an input to the hint application framework along with the query plan, allowing the framework to reconstruct the plan according to the specified join order.

This directive specifies a bushy join order, where the join operations are not strictly linear but can involve multiple branches being joined together. The optimizer (e.g., query optimizer 230) uses this directive to reconstruct the query plan accordingly, ensuring that the joins are executed in the specified order.

This hint specification translates to a bushy join tree pattern that can be represented as the following:
((A, B), (C, D))

This structure demonstrates how the join order hint can be used to explicitly define a bushy join pattern, where pairs of tables are joined independently before being combined in the final join operation.

The following is an overview of the bottom-up plan reconstruction framework's input-output structure.

Examples of inputs include the following:
1. A query plan including an arbitrary join order
2. A directive specifying the desired join order hint

Examples of an output include the following:
A transformed query plan that conforms to the join order specified in the directive
This framework processes the aforementioned components by taking the initial arbitrary query plan, applying the specified join order hint, and producing a restructured query plan that precisely matches the join ordering instructions contained in the directive.

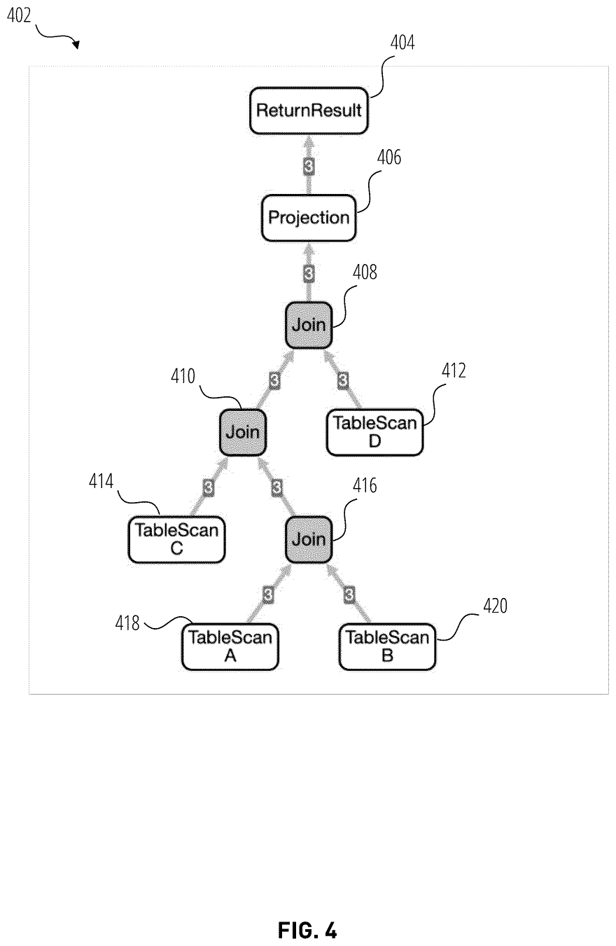

FIG. 4 illustrates an example of an input query plan with an arbitrary join order, in accordance with an embodiment of the subject technology.

FIG. 4 shows an input query plan 402 with an arbitrary join order that incudes the following structure.

At the top level, there is a return result operator 404 node, followed by a projection operator 406 node. Below that, there is a series of three join nodes (join operator 408, join operator 410, and join operator 416) arranged in a linear (non-bushy) pattern.

The topmost join operator 408 connects to:
A table scan operator 412 node for table D on one side
Another join operator 410 node on the other side

The middle join operator 410 connects to:
A table scan operator 414 node for table C on one side
The bottom join operator 416 node on the other side

The bottom join operator 416 connects to:
A table scan operator 418 node for table A on one side
A table scan operator 420 node for table B on the other side

FIG. 4 represents the initial arbitrary join order before the bottom-up plan reconstruction process is applied to transform it into the desired bushy join pattern.

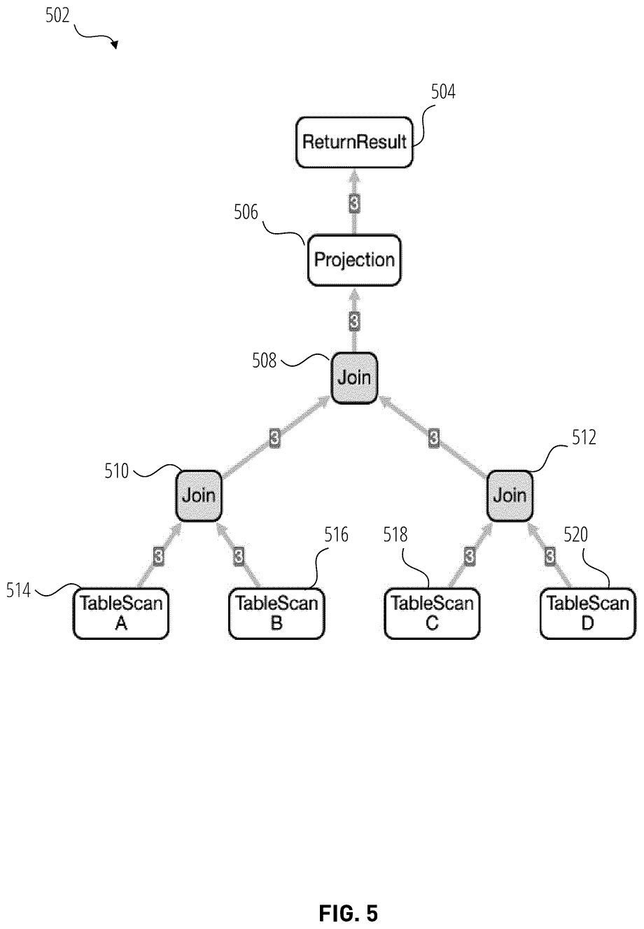

FIG. 5 illustrates an example output query plan matching the join order hint, in accordance with an embodiment of the subject technology.

In the example of FIG. 5, output query plan 502 matches the specified join order hint, showing a bushy join pattern structure as described as follows.

At the top level, the output query plan 502 includes:
A return result operator 504 node

### a Projection Operator 506 Node

A series of join nodes (join operator 508, join operator 510, join operator 512) arranged in a bushy pattern

The bushy join pattern is structured as described in the following.

The topmost join operator 508 connects:
Two lower-level join operator 510 and join operator 512 nodes (e.g., creating the bushy pattern)

The left-side join operator 510 connects:
A table scan operator 514 node for table A
A tablescan operator 516 node for table B

The right-side join operator 512 connects:
A table scan operator 518 node for table C
A table scan operator 520 node for table D

This transformed plan structure represents the final output after bottom-up plan reconstruction has been applied, implementing the join order hint: ((A, B), (C, D)).

The following is a description of the hint application framework's logical steps (e.g., as performed by plan reconstruction engine 228).

In an implementation, the framework stages include the following.
1. Query Block Boundary Identification

The framework begins by analyzing the initial query plan (with arbitrary join order) to identify logical query blocks that correspond to specific sections of the plan where joins can be reordered.
2. Dismantle Step

The dismantle step produces three types of outputs for each query block:
i. Mapping of aliases to plan fragments
ii. All predicates from inner joins and filter nodes
iii. Mapping of each non-inner join's non-preserved side fragments, including original join types and predicates

In an example, a non-inner join differs from an inner join in how it handles rows that do not meet the join condition. While an inner join only includes rows where there is a match in both tables, non-inner joins can include rows from one or both tables even if there is no match. Some example types of non-inner joins are left outer joins, right outer joins, and full outer joins.

In a query plan, non-inner joins can be represented as join nodes with additional metadata indicating the type of join and how to handle non-matching rows. For example, a left outer join node can include information about which table is the left table and how to fill in NULL values for non-matching rows from the right table.

In the context of non-inner joins, the term “non-preserved side fragments” refers to the portions of the query plan that correspond to the side of the join where rows may not be preserved if there is no matching row in the other table. Non-inner joins can include left outer joins, right outer joins, and full outer joins, and each of these joins has a preserved side and a non-preserved side.

In a query plan, non-preserved side fragments refer to the parts of the plan that correspond to the non-preserved side of a non-inner join. Such fragments can include the table scans, subqueries, or intermediate results that are on the non-preserved side of the join.
3. Reconstruction Process

The reconstruction process includes two distinct stages:

### Stage 1: Query Plan Shape Construction

Reassembles plan fragments following the join order directive
Constructs new inner join nodes as cartesian joins (using 1=1 join keys)
Places collected join keys and join filters as a filter node above the topmost join
Places non-inner join keys by looking up the map (from iii of the dismantle step described above) with the non-preserved side fragment
Produces a semantically equivalent intermediate plan

### Stage 2: Optimal Join Key Derivation

Focuses on deriving optimal join keys for constructed nodes
Utilizes the JoinFilterPushRule from the cost-based optimizer to:
   Push filters through join nodes
   Convert filter conjuncts to join keys where possible
Creates optimal join keys for cartesian joins
Handles non-inner join key derivation separately from Stage 1, without using JoinFilterPushRule

A cartesian join, also known as a cross join, is a type of join operation in SQL that returns the cartesian product of two tables. In an example, every row from a first table is combined with every row from a second table, resulting in a set of all possible combinations of rows from the two tables. Unlike other types of joins, a cartesian join does not require a join condition.

The following is a description of inner join query block processing.

The framework processes a query plan including a single logical query block where all joins are inner joins.

During a dismantle step, the subject system performs two operations:
1. Fragment Identification: The system identifies and isolates relevant plan fragments within the query block
2. Alias Mapping: Creates direct mappings between the plan fragments and their corresponding hint aliases for terminal nodes specified in the hint string

In an example, a plan fragment is a portion of a query plan that represents a specific subset of operations or steps within the overall execution plan for a SQL query. In the context of query optimization and execution, a plan fragment typically corresponds to a logical unit of work that can be independently processed or optimized. Plan fragments can be used to break down complex query plans into more manageable pieces, allowing for more efficient optimization and execution.

The subject system establishes straightforward one-to-one mappings between table scan nodes and their respective hint aliases:
TableScan A →alias “A”
TableScan B →alias “B”
And so Forth for Each Table Scan Node

This mapping process creates the foundation for subsequent reconstruction steps by establishing clear relationships between the physical plan components and their logical representations in the hint structure.

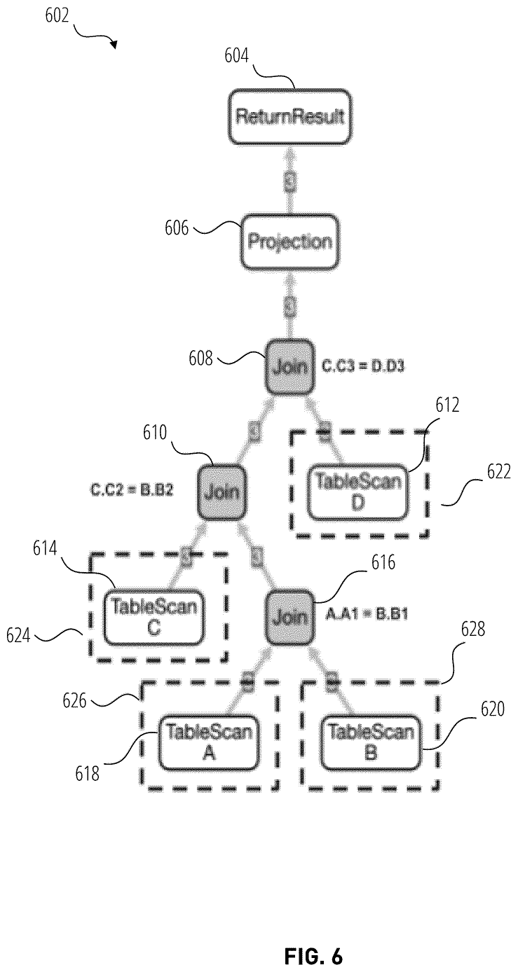

FIG. 6 illustrates an example of a query plan with a query block with inner join only, in accordance with an embodiment of the subject technology.

FIG. 6 illustrates the plan fragments and join keys from an input query plan 602, with the following elements.
A return result operator 604 node at the top of input query plan 602
A projection operator 606 node below return result operator 604
A hierarchical structure of three join nodes with their associated join keys:
   1. Top join operator 608 with predicate “C.C3=D.D3”
   2. Middle join operator 610 with predicate “C.C2=B.B2”
   3. Bottom join operator 616 with predicate “A.A1=B.B1”

The plan fragments (plan fragment 622, plan fragment 624, plan fragment 626, plan fragment 628) map to specific hint aliases of various terminal nodes:
table scan operator 618 A maps to alias “A”
table scan operator 620 B maps to alias “B”
table scan operator 614 C maps to alias “C”
table scan operator 612 D maps to alias “D”

The example of FIG. 6 demonstrates the initial stage of the dismantle step, where the framework, provided by plan reconstruction engine 228, identifies the relevant plan fragments and establishes mappings between the table scan nodes and their corresponding hint aliases, while preserving the original join keys from the input plan.

In this example, the collected information after the dismantle step will be the following:
Mapping for alias: plan fragments
   {A: TableScanA, B: TableScanB, C: TableScanC, D: TableScanD}
All predicates from inner join and filter node
   A.a1=B.b1 and C.c2=B. b2 and C.c3=D. d3
Mapping for non-inner join's non-preserved side fragment: original non-inner join's join type & join predicate

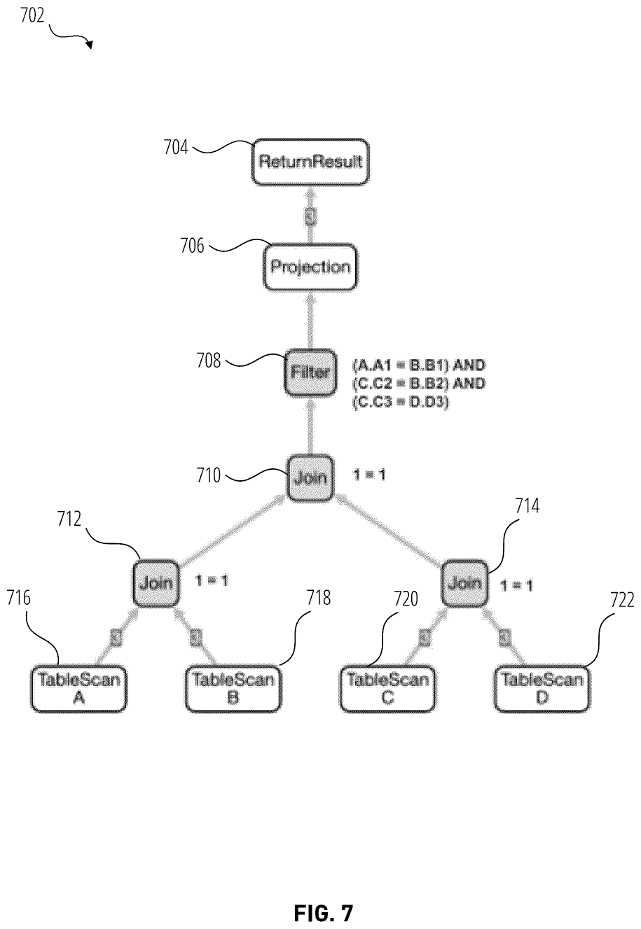

FIG. 7 illustrates an example of a query plan illustrating a reconstruction step for optimal join key derivation, in accordance with an embodiment of the subject technology.

In the example of FIG. 7, the following is the desired join order:
{“qb1_0”: [“A”,“B”],“qb1_1”: [“C”,“D”],“qb1_2”: [“SYS_JOIN_1_0”,“SY S_JOIN_1_1”]}

### →((A, B), (C, D))

The subject technology constructs all the joins according to the given order, and keep the all inner join predicates as 1=1 (cross join). Moreover, all predicates are placed in a top filter node.

FIG. 7 illustrates the semantically equivalent plan generated after Stage 1 of plan reconstruction, showing the following hierarchical structure.

At the top level of query plan 702 are the following:
return result operator 704 node
projection operator 706 node
filter operator 708 node including all of the original join predicates: “(A. A1=B. B1) AND (C.c2=B.b2) AND (C.c3=D.d3)”

The join structure demonstrates a bushy pattern with the following:
1. A top-level join operator 710 node using a temporary “1=1” predicate
2. Two lower-level join operator 712 and join operator 714 nodes, each also using “1 =1”predicates:
   Left side: join operator 712 connecting table scan operator 716 A and table scan operator 718 B
   Right side: join operator 714 connecting table scan operator 720 C and table scan operator 722 D

This represents an intermediate stage where:
The join structure has been reconstructed according to the specified hint
All joins are temporarily set as cartesian joins (using “1=1”)
The actual join conditions are collected and placed in the top Filter node
The plan maintains semantic equivalence with the input plan while preparing for optimal join key derivation in Stage 2

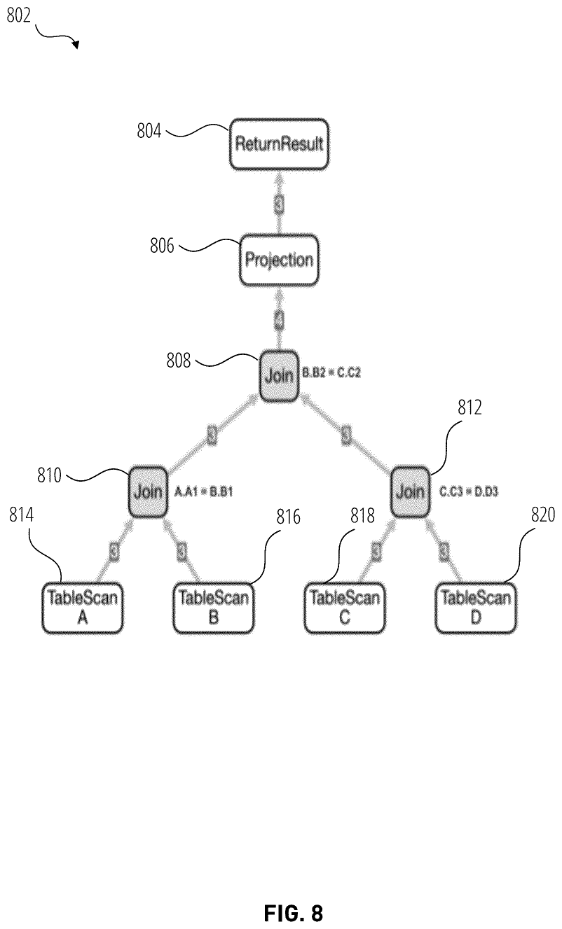

FIG. 8 illustrates an example of a query plan 802 showing a reconstruction step for the construction of the (final) query plan shape.

FIG. 8 illustrates the final query plan with optimal join keys derived after Stage 2 of plan reconstruction, with the following structure as described.

At the top level:
return result operator 804 node
projection operator 806 node

The join structure demonstrates a bushy pattern with optimized join keys:
1. Top-level join operator 808 using the predicate “B.B2=C.C2”
2. Two lower-level joins:
   Left side: join operator 810 connecting table scan operator 814 A and table scan operator 816 B using predicate “A.A1=B.B1”
   Right side: join operator 812 connecting table scan operator 818 C and table scan operator 820 D using predicate “C.C3=D.D3”

This represents the final output where:
The temporary cartesian joins (1=1) have been replaced with optimal join keys
The join predicates have been pushed down from the filter node to their appropriate join nodes
The plan maintains the bushy join pattern specified in the hint while incorporating the optimal join conditions

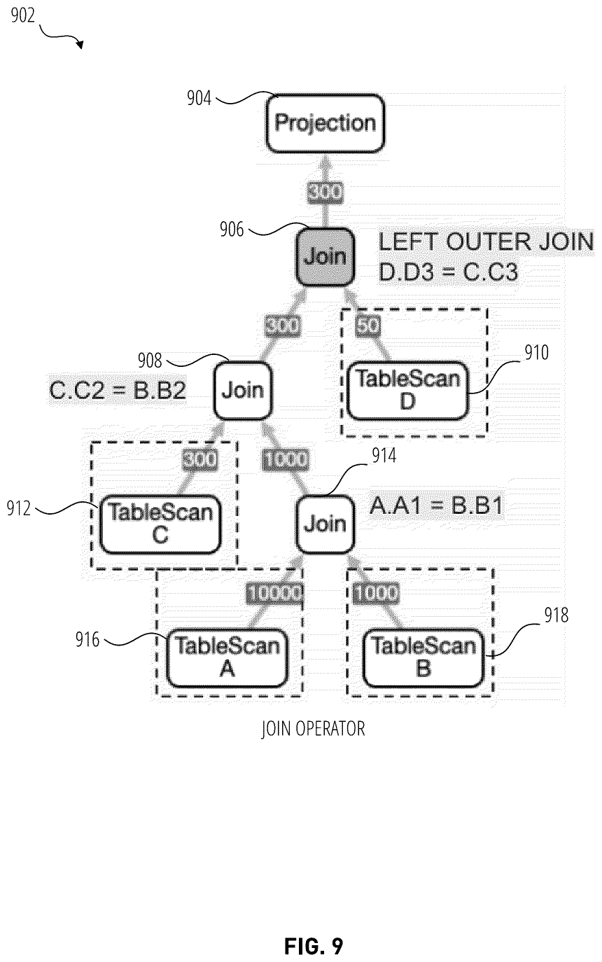

FIG. 9 illustrates an example of a query plan 902 including a query block with non-inner join processing, in accordance with an embodiment of the subject technology.

In a dismantle step, the framework, provided by plan reconstruction engine 228, processes a query plan shown in FIG. 9 that mirrors the previous example's structure, with one crucial difference e.g., the uppermost join is a LEFT OUTER join rather than an INNER join.

The following relates to key processing differences.

The dismantling process handles the non-inner join distinctly:

### 1. Predicate Management

The non-inner join predicate (D.D3=C.C3) receives special treatment
Instead of inclusion in the general “All predicates” collection, it is maintained in a separate non-inner join mapping structure 2. Mapping Configuration
Key: The non-preserved side child node (D)
Value: A composite including:
   Join type specification (LEFT OUTER)
   Associated join predicate (D.D3=C.C3)

The following relates to reconstruction implications.

This specialized mapping structure facilitates direct information retrieval during reconstruction, governed by a fundamental constraint:
The non-preserved side of the join (D) must maintain its position as a direct child of the LEFT OUTER join
Join reordering operations cannot traverse through the non-preserved side

This architectural decision ensures that the LEFT OUTER join's semantics are preserved throughout the reconstruction process while maintaining the integrity of the original query plan.

FIG. 9 illustrates an input query plan that includes the following structure.

At the top level:
projection operator 904 node (receiving value 300)
A LEFT OUTER join operator 906 node with predicate “D.D3=C.C3” (output of value 300)

The join structure includes the following.

Top-level LEFT OUTER join operator 906 connecting:
table scan operator 910 D (output of value 50)
A middle join operator 908 node (output of value 300)

Middle join operator 908 with predicate “C.C2=B.B2” connecting:
table scan operator 912 C (output of value 300)
A bottom join operator 914 node (output of value 1000)

Bottom join operator 914 with predicate “A.A1=B.B1” connecting:
table scan operator 916 A (output of value 10000)
table scan operator 918 B (output of value 1000)

FIG. 9 provides an example of a query plan that includes both inner joins and a non-inner join (LEFT OUTER JOIN), which requires special handling during the dismantle and reconstruction process to preserve the join types and predicates.

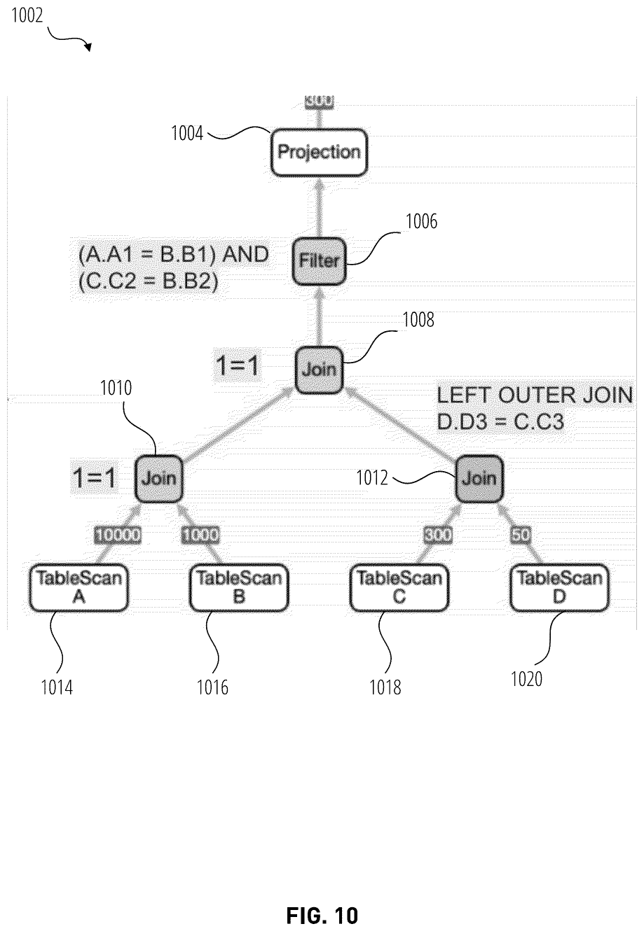

FIG. 10 illustrates an example of a query plan in a reconstruction step for optimal join key derivation, in accordance with an embodiment of the subject technology.

In the example of FIG. 10, an intermediate plan (e.g., query plan 1002) is generated for a query plan including a non-inner join, showing the following structure.

The subject system processes the following join order:
{“qb1_0”: [“A”, “B”], “qb1_1”: [“C”, “D”], “qb1_2”:
[“SYS_JOIN_1_0”, “SYS_JOIN_1_1”]}

This directive specifies a bushy join pattern: ((A, B), (C, D))

The reconstruction process performs the following steps:

### 1. Join Construction

Builds all joins according to the specified order
Sets inner join predicates as temporary cartesian joins (1=1)

### 2. Special Handling for Non-Inner Joins

For joins including D as a child node:
References the non-inner join mapping from the dismantle step
Applies the original join type (LEFT OUTER)
Preserves the original join predicate

### 3. Predicate Management

Places remaining predicates in a top-level Filter node
Maintains semantic equivalence with the original query plan while preserving the non-inner join characteristics

This approach ensures proper handling of both inner and non-inner joins while maintaining the specified join order structure.

As shown, query plan 1002 includes at the top level:
projection operator 1004 node (with an output of value 300)
filter operator 1006 node including inner join predicates: “(A.A1=B.B1) AND (C.C2=B.B2)”

The join structure demonstrates the following.

Top-level join operator 1008 node using “1=1” predicate which includes:
connecting left join operator 1010 node using “1=1” predicate
connecting right join operator 1012 node using predicate “D.D3=C.C3”

Lower-level joins which include:
Left join operator 1010 node connecting table scan operator 1014 A (with an output of value 10000) and table scan operator 1016 B (with an output of value 1000) using “1 32 1” predicate
Right join operator 1012 node of the LEFT OUTER JOIN type, using predicate “D.D3=C.C3”, connecting table scan operator 1018 C (with an output of value 300) and table scan operator 1020 D (without an output of value 50)

This intermediate plan shows how:
The LEFT OUTER JOIN's type and predicate are preserved from the original plan
Inner joins are temporarily set as cartesian joins (1=1)
Inner join predicates are collected in the top Filter node
The plan maintains semantic equivalence while preparing for optimal join key derivation

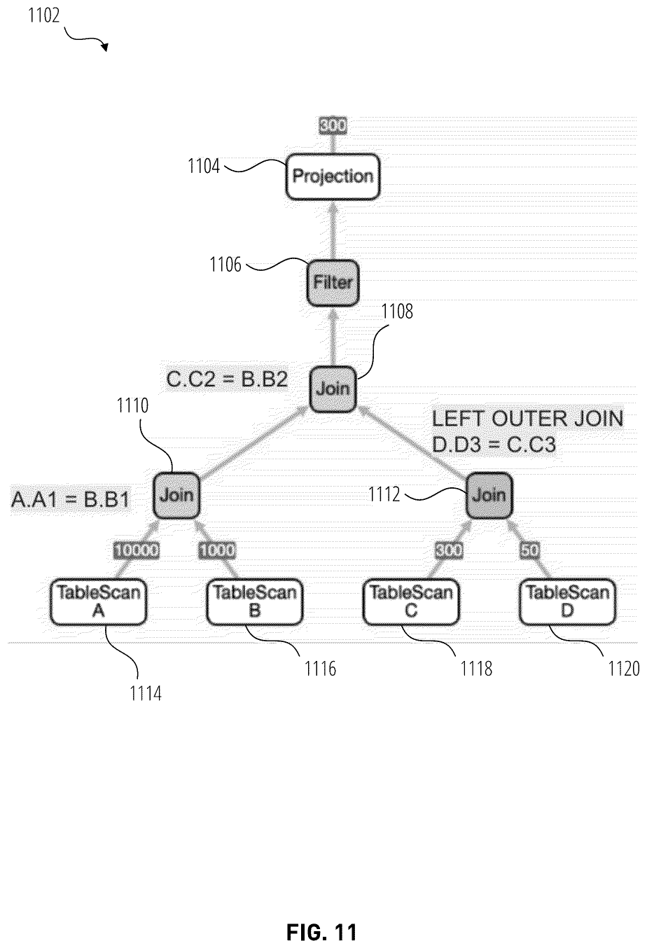

FIG. 11 illustrates an example of a query plan in a reconstruction step of constructing the query plan shape, in accordance with an embodiment of the subject technology.

FIG. 11 illustrates the final query plan (e.g., query plan 1102) after complete reconstruction, with the following structure.

At the top level of query plan 1102:
projection operator 1104 node (with an output of value 300)
filter operator 1106 node

The join structure demonstrates a hierarchical arrangement with optimized join keys:
1. Top-level join operator 1108 node, using predicate “C.C 2=B.B2”
2. Two lower-level joins:
   Left join (e.g., join operator 1110 node) using predicate “A.A1=B.B1” connecting:
      table scan operator 1114 A (with an output of value 10000)
      table scan operator 1116 B (with an output of value 1000)
   Right join operator 1112 of LEFT OUTER JOIN type using predicate “D.D3=C.C3” connecting:
      table scan operator 1118 C (with an output of value 300)
      table scan operator 1120 D (with an output of value 50)

In this example, query plan 1102 represents the final optimized plan where:
The LEFT OUTER JOIN type and predicate have been preserved
Join predicates have been pushed down to their appropriate join nodes
The plan maintains both the specified join order and the semantic integrity of the non-inner join operations

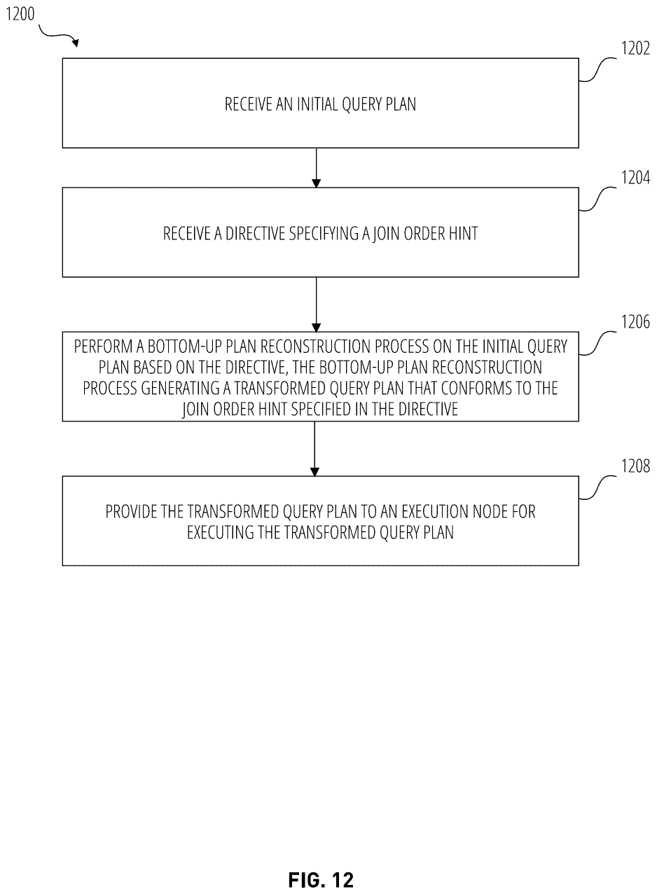

FIG. 12 is a flow diagram illustrating operations of a database system in performing a method 1200, in accordance with some embodiments of the present disclosure. The method 1200 may be embodied in computer-readable instructions for execution by one or more hardware components (e.g., one or more processors) such that the operations of the method 1200 may be performed by components of data platform 102. Accordingly, the method 1200 is described below,

by way of example with reference thereto. However, it shall be appreciated that method 1200 may be deployed on various other hardware configurations and is not intended to be limited to deployment within the data platform 102.

At operation 1202, query optimizer 230 receives an initial query plan.

At operation 1204, query optimizer 230 receives a directive specifying a join order hint.

At operation 1206, plan reconstruction engine 228 performs a bottom-up plan reconstruction process on the initial query plan based on the directive, the bottom-up plan reconstruction process generating a transformed query plan that conforms to the join order hint specified in the directive.

At operation 1208, query optimizer 230 provides the transformed query plan to an execution node for executing the transformed query plan.

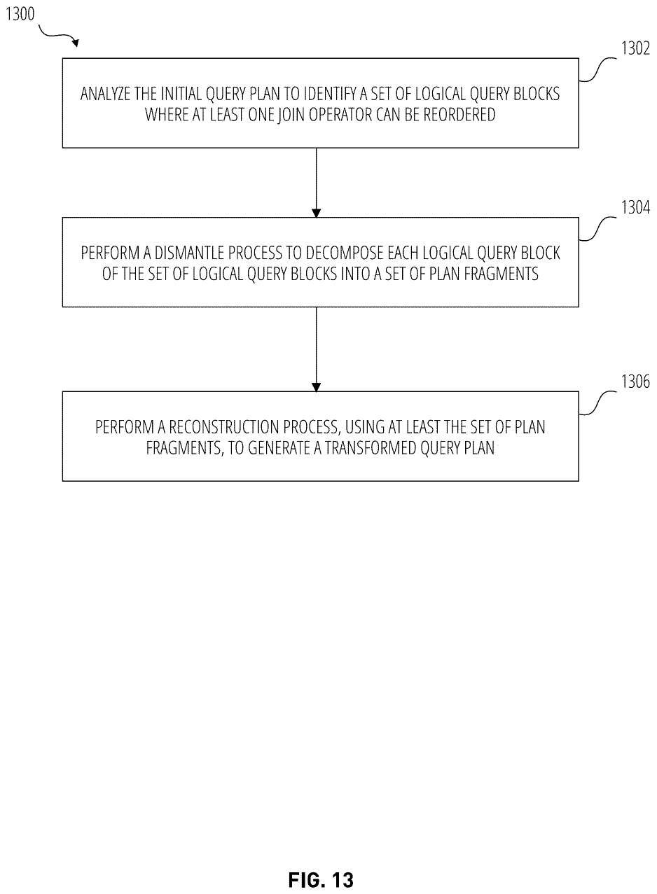

FIG. 13 is a flow diagram illustrating operations of a database system in performing a method 1300, in accordance with some embodiments of the present disclosure. The method 1300 may be embodied in computer-readable instructions for execution by one or more hardware components (e.g., one or more processors) such that the operations of the method 1300 may be performed by components of data platform 102. Accordingly, the method 1300 is described below, by way of example with reference thereto. However, it shall be appreciated that method 1300 may be deployed on various other hardware configurations and is not intended to be limited to deployment within the data platform 102.

At operation 1302, plan reconstruction engine 228 analyzes the initial query plan to identify a set of logical query blocks where at least one join operator can be reordered

At operation 1304, plan reconstruction engine 228 performs a dismantle process to decompose each logical query block of the set of logical query blocks into a set of plan fragments.

At operation 1306, plan reconstruction engine 228 performs a reconstruction process, using at least the set of plan fragments, to generate a transformed query plan.

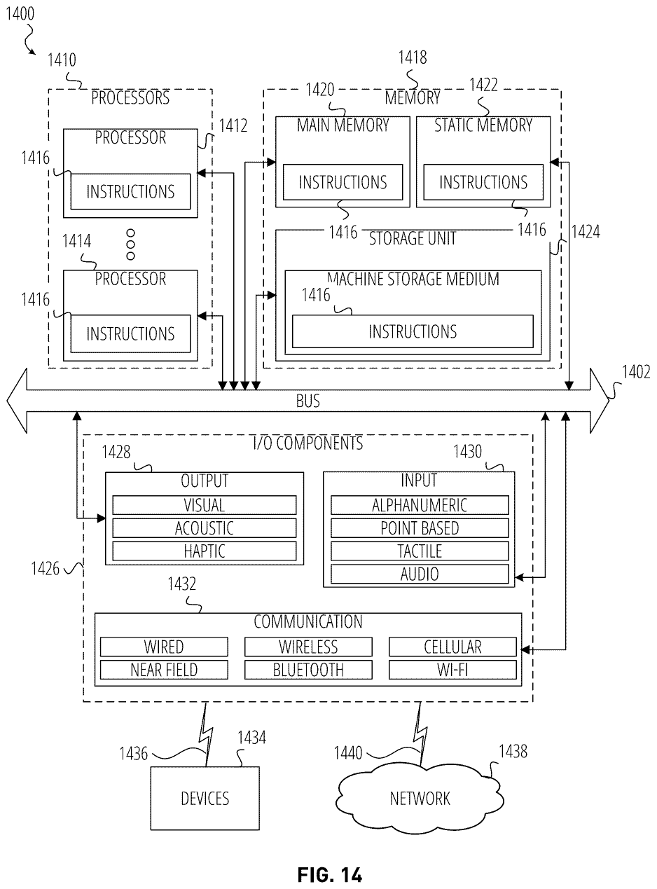

FIG. 14 illustrates a diagrammatic representation of a machine 1400 in the form of a computer system within which a set of instructions may be executed for causing the machine 1400 to perform any one or more of the methodologies discussed herein, according to an example embodiment. Specifically, FIG. 14 shows a diagrammatic representation of the machine 1400 in the example form of a computer system, within which instructions 1416 (e.g., a software, a program, an application, an applet, an app, or other executable code) for causing the machine 1400 to perform any one or more of the methodologies discussed herein may be executed. For example, the instructions 1416 may cause the machine 1400 to execute any one or more operations of the methods described herein. As another example, the instructions 1416 may cause the machine 1400 to implement any one or more portions of the functionality illustrated in any one of figures described herein. In this way, the instructions 1416 transform a general, non-programmed machine into a particular machine that is specially configured to carry out any one of the described and illustrated functions of the data platform 102 such as the compute service manager 108 (or a component thereof or an execution node of the execution platform 110.

In some embodiments, the machine 1400 operates as a standalone device or may be coupled (e.g., networked) to other machines. In a networked deployment, the machine 1400 may operate in the capacity of a server machine or a client machine in a server-client network environment, or as a peer machine in a peer-to-peer (or distributed) network environment. The machine 1400 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 1416, sequentially or otherwise, that specify actions to be taken by the machine 1400. Further, while only a single machine 1400 is illustrated, the term “machine” shall also be taken to include a collection of machines machine 1400 that individually or jointly execute the instructions 1416 to perform any one or more of the methodologies discussed herein.

The machine 1400 includes processors 1410, 1412, and i/o components 1426 configured to communicate with each other such as via a bus 1402. In an example embodiment, the processors 1410 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1414 and a processor 1412 that may execute the instructions 1416. The term “processor” is intended to include multi-core processors 1410 that may comprise two or more independent processors (sometimes referred to as “cores”) that may execute instructions 1416 contemporaneously. Although FIG. 14 shows multiple processors 1410, the machine 1400 may include a single processor with a single core, a single processor with multiple cores (e.g., a multi-core processor), multiple processors with a single core, multiple processors with multiple cores, or any combination thereof.

The memory 1418 may include a main memory 1420, a static memory 1422, and a storage unit 1424, all accessible to the processors 1410 such as via the bus 1402. The main memory 1420, the static memory 1422, and the storage unit 1424 store the instructions 1416 embodying any one or more of the methodologies or functions described herein. The instructions 1416 may also reside, completely or partially, within the main memory 1420, within the static memory 1422, within the storage unit 1424, within at least one of the processors 1410 (e.g., within the processor's cache memory), or any suitable combination thereof, during execution thereof by the machine 1400.

The i/o components 1426 include components to receive input, provide output, produce output, transmit information, exchange information, capture measurements, and so on. The specific i/o components 1426 that are included in a particular machine 1400 will depend on the type of machine. For example, portable machines such as mobile phones will likely include a touch input device or other such input mechanisms, while a headless server machine will likely not include such a touch input device. It will be appreciated that the i/o components 1426 may include many other components that are not shown in FIG. 14. The i/o components 1426 are grouped according to functionality merely for simplifying the following discussion and the grouping is in no way limiting. In various example embodiments, the i/o components 1426 may include output components 1428 and input components 1430. The output components 1428 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 1430 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The i/o components 1426 may include communication components 1432 operable to couple the machine 1400 to a network 1438 or devices 1434 via a coupling 1440 and a coupling 1436, respectively. For example, the communication components 1432 may include a network interface component or another suitable device to interface with the network 1438. In further examples, the communication components 1432 may include wired communication components, wireless communication components, cellular communication components, and other communication components to provide communication via other modalities. The devices 1434 may be another machine or any of a wide variety of peripheral devices (e.g., a peripheral device coupled via a universal serial bus (USB)). For example, as noted above, the machine 1400 may correspond to any one of the compute service manager 108, the execution platform 110, and the devices 1434 may include the data store 206 or any other computing device described herein as being in communication with the data platform 102 or the data storage 104.

The various memories (e.g., memory 1418, main memory 1420, static memory 1422, and/or memory of the processor(s) 1410 and/or the storage unit 1424) may store one or more sets of instructions 1416 and data structures (e.g., software) embodying or utilized by any one or more of the methodologies or functions described herein. These instructions 1416, when executed by the processor(s) 1410, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage medium,” “computer-storage medium,” and “device-storage medium” specifically exclude carrier waves, modulated data signals, and other such media, at least some of which are covered under the term “signal medium” discussed below.

In various example embodiments, one or more portions of the network 1438 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1438 or a portion of the network 1438 may include a wireless or cellular network, and the coupling 1440 may be a Code Division Multiple Access (CDMA) connection, a Global System for Mobile communications (GSM) connection, or another type of cellular or wireless coupling. In this example, the coupling 1440 may implement any of a variety of types of data transfer technology, such as Single Carrier Radio Transmission Technology (1x RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1416 may be transmitted or received over the network 1438 using a transmission medium via a network interface device (e.g., a network interface component included in the communication components 1432) and utilizing any one of a number of well-known transfer protocols (e.g., hypertext transfer protocol (HTTP)). Similarly, the instructions 1416 may be transmitted or received using a transmission medium via the coupling 1436 (e.g., a peer-to-peer coupling) to the devices 1434. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1416 for execution by the machine 1400, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor implemented. For example, at least some of the operations of a method may be performed by one or more processors. The performance of certain of the operations may be distributed among the one or more processors, not only residing within a single machine, but also deployed across a number of machines. In some example embodiments, the processor or processors may be in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Thus, although specific embodiments have been illustrated and described herein, it should be appreciated that any arrangement calculated to achieve the same purpose may be substituted for the specific embodiments shown. This disclosure is intended to cover all adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A system comprising:
at least one hardware processor; and
a memory storing instructions that cause the at least one hardware processor to perform operations comprising:
receiving an initial query plan;
receiving a directive specifying a join order hint;
performing a bottom-up plan reconstruction process on the initial query plan based on the directive, the bottom-up plan reconstruction process generating a transformed query plan that conforms to the join order hint specified in the directive; and
providing the transformed query plan to an execution node for executing the transformed query plan.

2. The system of claim 1, further comprising:
analyzing the initial query plan to identify a set of logical query blocks where at least one join operator can be reordered; and
performing a dismantle process to decompose each logical query block of the set of logical query blocks into a set of plan fragments.

3. The system of claim 2, wherein the dismantle process, for each logical query block, generates a mapping of aliases to particular plan fragments from the set of plan fragments, a set of predicates from inner joins or filter nodes, and a mapping of non-preserved side fragments of each non-inner join.

4. The system of claim 3, further comprising:
performing a reconstruction process, using at least the set of plan fragments, to generate a transformed query plan.

5. The system of claim 4, wherein the reconstruction process comprises:
performing a query plan shape construction process, the query plan shape construction process comprising:
reassembling the set of plan fragments based on the directive;
constructing a set of new inner join nodes as cartesian joins;
placing collected join keys and join filters as a filter node above a topmost join node; and
generating a semantically equivalent intermediate plan.

6. The system of claim 3, wherein the dismantle process further comprises:
storing a set of non-inner join keys separately from the join keys from the inner joins.

7. The system of claim 3, further comprising:
placing a set of non-inner join keys by looking up the mapping of non-preserved side fragments with a particular non-preserved side fragment.

8. The system of claim 5, further comprising:
deriving a set of optimal join keys from a set of constructed nodes from the semantically equivalent intermediate plan.

9. The system of claim 8, further comprising:
pushing at least one filter through join nodes.

10. The system of claim 8, further comprising:
converting at least one filter conjunct to a set of join keys.

11. A method comprising:
receiving an initial query plan;
receiving a directive specifying a join order hint;
performing a bottom-up plan reconstruction process on the initial query plan based on the directive, the bottom-up plan reconstruction process generating a transformed query plan that conforms to the join order hint specified in the directive; and
providing the transformed query plan to an execution node for executing the transformed query plan.

12. The method of claim 11, further comprising:
analyzing the initial query plan to identify a set of logical query blocks where at least one join operator can be reordered; and
performing a dismantle process to decompose each logical query block of the set of logical query blocks into a set of plan fragments.

13. The method of claim 12, wherein the dismantle process, for each logical query block, generates a mapping of aliases to particular plan fragments from the set of plan fragments, a set of predicates from inner joins or filter nodes, and a mapping of non-preserved side fragments of each non-inner join.

14. The method of claim 13, further comprising:
performing a reconstruction process, using at least the set of plan fragments, to generate a transformed query plan.

15. The method of claim 14, wherein the reconstruction process comprises:
performing a query plan shape construction process, the query plan shape construction process comprising:
reassembling the set of plan fragments based on the directive;
constructing a set of new inner join nodes as cartesian joins;
placing collected join keys and join filters as a filter node above a topmost join node; and
generating a semantically equivalent intermediate plan.

16. The method of claim 13, further comprising:
storing a set of non-inner join keys separately from the join keys from the inner joins.

17. The method of claim 13, further comprising:
placing a set of non-inner join keys by looking up the mapping of non-preserved side fragments with a particular non-preserved side fragment.

18. The method of claim 15, further comprising:
deriving a set of optimal join keys from a set of constructed nodes from the semantically equivalent intermediate plan.

19. The method of claim 18, further comprising:
pushing at least one filter through join nodes; and
converting at least one filter conjunct to a set of join keys.

20. A non-transitory computer-storage medium comprising instructions that, when executed by one or more processors of a machine, configure the machine to perform operations comprising:
receiving an initial query plan;
receiving a directive specifying a join order hint;
performing a bottom-up plan reconstruction process on the initial query plan based on the directive, the bottom-up plan reconstruction process generating a transformed query plan that conforms to the join order hint specified in the directive; and
providing the transformed query plan to an execution node for executing the transformed query plan.
